(19) United States
(12) Patent Application Publication
(10) Pub. No.: US 2025/0297123 A1
(43) Pub. Date: Sep. 25, 2025

(54) INK SET, DEVICE FOR DISCHARGING LIQUID, METHOD OF DISCHARGING LIQUID

(71) Applicants: Tomohiro NAKAGAWA, Kanagawa (JP); Hiroki KOBAYASHI, Kanagawa (JP); Daiki HYAKUTAKE, Kanagawa (JP)

(72) Inventors: Tomohiro NAKAGAWA, Kanagawa (JP); Hiroki KOBAYASHI, Kanagawa (JP); Daiki HYAKUTAKE, Kanagawa (JP)

(21) Appl. No.: 19/082,456

(22) Filed: Mar. 18, 2025

(30) Foreign Application Priority Data
Mar. 22, 2024 (JP) 2024-046863

(51) Int. Cl. C09D 11/54; B41J 3/407; B41J 11/00; C09D 11/38; C09D 11/40; D06P 5/00; D06P 5/20; D06P 5/30

(52) U.S. Cl. CPC C09D 11/54; B41J 3/4078; B41J 11/002; C09D 11/38; C09D 11/40; D06P 5/002; D06P 5/2066; D06P 5/30

(57) ABSTRACT

An ink set contains a pre-processing fluid containing a flocculant in an amount of at most 35 percent by mass and an ink that contains water, an organic solvent, a resin accounting for at least 6 percent by mass of the ink, a pigment, and a silicone oil or the solid content of a wax in an amount of at least 0.5 percent by mass to the entire of the ink, wherein an image has a static friction coefficient of at most 0.47, the image being formed by applying the pre-processing fluid to a fabric, applying the ink where the pre-processing fluid is applied to the fabric, and heating the fabric.

### CROSS-REFERENCE TO RELATED APPLICATION

This patent application is based on and claims priority pursuant to 35 U.S.C. § 119 to Japanese Patent Application No. 2024-046863, filed on Mar. 22, 2024, in the Japan Patent Office, the entire disclosure of which is hereby incorporated by reference herein.

### BACKGROUND

### Technical Field

The present disclosure is related to an ink set, a device for discharging a liquid, and a method of discharging a liquid.

### Description of the Related Art

Inkjet printers have advantages such as low noise, low running costs, and ease of color printing, making them widely used as digital output devices in general households. In recent years, inkjet printers have been used not only at home but also for printing on low-permeability media such as coated paper, non-absorbent media such as plastic films, and fabrics such as woven and knitted textiles. Inkjet printers are now required to achieve image quality comparable to conventional analog printing.

In the field of textile printing, the market for printing an aqueous ink directly onto garments such as T-shirts and fabric substrates before sewing has been expanding year by year. In addition to traditional cotton and cotton-polyester blended media, the demand for polyester media has been increasing rapidly, particularly for sportswear applications. As a result, there is a growing demand for inkjet printing systems capable of forming images with excellent color development and various fastness properties on a wide range of materials, including cotton and polyester.

As the inks for such applications, dye-based inks containing reactive dyes or acid dyes are widely used. However, dye inks have the drawback of imposing a high environmental burden due to the need for large amounts of water in the post-treatment washing process. Consequently, there is growing interest in pigment inks, which offer the advantages of requiring only a heating process for post-treatment and having high versatility, as they are less dependent on the type of substrate.

### SUMMARY

According to embodiments of the present disclosure, an ink set is provided which contains a pre-processing fluid containing a flocculant in an amount of at most 35 percent by mass and an ink that contains water, an organic solvent, a resin accounting for at least 6 percent by mass of the ink, a pigment, and a silicone oil or the solid content of a wax in an amount of at least 0.5 percent by mass to the entire of the ink, wherein an image has a static friction coefficient of at most 0.47, the image being formed by applying the pre-processing fluid to a fabric, applying the ink where the pre-processing fluid is applied to the fabric, and heating the fabric.

As another aspect of embodiments of the present disclosure, a device for discharging a liquid is provided which contains a first discharging device to discharge a pre-processing fluid to a fabric and a second discharging device to discharge an ink to the fabric where the pre-processing fluid is discharged, wherein the pre-processing fluid contains a flocculant in an amount of at most 35 percent by mass and the ink contains water, an organic solvent, a resin accounting for at least 6 percent by mass of the ink, a pigment, and a silicone oil or a solid content of a wax in an amount of at least 0.5 percent by mass to the entire of the ink, wherein an image has a static friction coefficient of at most 0.47, the image being formed by applying the pre-processing fluid to the fabric, applying the ink where the pre-processing fluid is applied to the fabric, and heating the fabric.

As another aspect of embodiments of the present disclosure, a method of discharging a liquid includes discharging a pre-processing fluid to a fabric and discharging an ink to the fabric where the pre-processing fluid is discharged, wherein the pre-processing fluid contains a flocculant in an amount of at most 35 percent by mass and the ink contains water, an organic solvent, a resin accounting for at least 6 percent by mass of the ink, a pigment, and a silicone oil or a solid content of a wax in an amount of at least 0.5 percent by mass to the entire of the ink, wherein an image has a static friction coefficient of at most 0.47, the image being formed by applying the pre-processing fluid to the fabric, applying the ink where the pre-processing fluid is applied to the fabric, and heating the fabric.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an example of a discharging device; and

FIG. 2 is a schematic diagram illustrating an example of an ink tank.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an ink set is provided which forms images with excellent friction fastness (rub fastness) even when fabric is pre-treated.

Since pigment inks form a structure where solid components adhere to the fibers, printed images tend to peel off easily when rubbed. To address this issue, increasing the amount of fixing components could be considered, but this would result in a stiff texture, compromising the tactile feel, which is highly valued in the apparel industry. Additionally, pre-treatment is often performed to prevent ink striking through, oozing, or bleeding, ensuring sharp image definition. Oozing or bleeding can be reduced by pre-treatment. For example, an ink set has been proposed in Japanese Patent No. 6596854 which is designed to prevent the mixing of different color liquids to improve image gloss and ink fixability.

The ink set, device for discharging a liquid, method of discharging a liquid, ink, and pre-processing fluid will now be described with reference to accompanying drawings. It is to be noted that the following embodiments are not limiting the present disclosure and any deletion, addition, modification, change, etc. can be made within a scope in which man in the art can conceive including other embodiments, and any of which is included within the scope of the present disclosure as long as the effect and feature of the present disclosure are demonstrated.

### Ink Set, Ink, and Pre-Processing Fluid

The ink set of the present disclosure contains a pre-processing fluid and an ink: the pre-processing fluid; contains a flocculant in an amount of at most 35 percent by mass; and the ink contains water, an organic solvent, a resin accounting for at least 6 percent by mass of the ink, a pigment, and a silicone oil or a solid content of a wax in an amount of at least 0.5 percent by mass to the entire of the ink, wherein an image has a static friction coefficient of at most 0.47, the image being formed by applying the pre-processing fluid to the fabric, applying the ink where the pre-processing fluid is applied to the fabric, and heating the fabric.

According to the investigations by the present inventors of the present invention, if the static friction coefficient of an image is at most 0.47 after applying a pre-processing fluid to fabric, then applying ink, and subsequently heating. friction fastness (rub fastness) is ensured. That is, the image maintains excellent rub fastness even when the fabric is pre-processed. If the static friction coefficient exceeds 0.47, the friction fastness of the image deteriorates.

To ensure that the static friction coefficient of an image after applying a pre-processing fluid and ink to a fabric and then heating remains at most 0.47, one approach is to include wax in the ink. Additionally, for example, silicone oil may be included in the ink.

The method of measuring the static friction coefficient is not particularly limited but can be performed as follows. A pre-processing fluid is discharged onto a fabric, followed by the discharge of ink, and then heating the fabric is performed to form an image. The image may be, for example, a solid image. A solid image cut to approximately 15 cm in length is placed in a TSf-503 automatic friction and wear analysis device, available from Kyowa Interface Science Co., Ltd., and rubbing is performed under the following measuring conditions.

The coefficient of friction at the moment when movement begins is read as the static friction coefficient.

### Measuring Conditions

Load: 200 g
Measuring speed: 1000 mm/min
Measuring distance 30 mm
Contact maker: R contact

The image used for measuring the static friction coefficient is formed by applying a pre-processing fluid to a fabric, then applying ink to the fabric, and subsequently heating the fabric. The term “heating” includes drying. The heating device is not particularly limited and may be, for example, either a contact-type or a non-contact-type device.

It should be noted that Japanese Patent No. 6596854 mentioned above primarily assumes the discharge of a treatment liquid onto printed ink, which differs from the image formation in the present disclosure. Additionally, Japanese Patent No. 6596854 mentioned above requires further verification regarding the use of fabric as printing medium. The ink set of the present disclosure forms an image by discharging ink after discharging a pre-processing fluid onto a fabric.

By discharging the pre-processing fluid onto the fabric, ink bleeding and strike-through can be prevented.

Furthermore, the present disclosure offers the advantage of excellent color development in images formed on fabric. In the present disclosure, a variety of colors can be selected for use as pigment inks, while in typical techniques, the range of colors that can be applied as pigment inks may be limited. Additionally, the ink used in the present disclosure has the advantage of good discharging stability.

The ink set of the present disclosure can be used in a device for discharging a liquid and a method of discharging a liquid based on inkjetting. The ink set of the present disclosure may also be referred to as an inkjet ink set or an equivalent term.

### Ink

The ink contains water, an organic solvent, a resin accounting for at least 6 percent by mass of the ink, a pigment, and a silicone oil or a wax at a solid content of at least 0.5 percent by mass to the entire of the ink, wherein an image has a static friction coefficient of at most 0.47 when the image is formed by applying the pre-processing fluid and the ink to fabric followed by heating the fabric, and the proportion of the resin in the ink is at least 6 percent by mass. The pre-processing fluid contains a flocculant in an amount of at most 35 percent by mass.

The ink of the present disclosure forms images with excellent friction fastness (rub fastness) even when fabric is pre-treated. The ink of the present disclosure exhibits excellent stability as a liquid and discharging stability. The ink set of the present disclosure contains an ink with good liquid stability and discharging stability, and a pre-processing fluid that can prevent ink bleeding and strike-through, enabling the formation of an image with excellent friction fastness even when fabric is subjected to pre-treatment.

The ink of the present disclosure contains water, an organic solvent, a resin, and a pigment, and further includes either silicone oil or wax. The ink may furthermore optionally include other materials. The ink contained in the ink set may be either a single type or multiple types, and may be a single color or multiple colors. Inclusion of wax or silicone oil in the ink makes it easier to achieve a static friction coefficient within the aforementioned range. From the perspective of maintaining good liquid stability and discharging stability, wax is preferred.

### Silicone Oil

As the silicone oil, for example, a liquid dispersion of long-chain polydimethylsiloxane can be used. If the ink contains silicone oil, the effective component content is preferably between 0.1 and 5.0 percent by mass of the entire ink.

### Wax

The type of wax is not particularly limited, but it is preferably added in the form of a wax particle dispersion, where the wax particles are dispersed in a liquid medium. If the ink contains wax, the wax molecules aligned on the surface help enhance liquid stability and discharging stability. As wax particles, both natural waxes and synthetic waxes can be used.

Examples of natural waxes include, but are not limited to, petroleum-based waxes, plant-based waxes, and animal-plant-based waxes.

Petroleum-based waxes: Paraffin wax, microcrystalline wax, petrolatum, and others.

Plant-based waxes: Carnauba wax, candelilla wax, rice wax, Japan wax, and others

Animal-plant-based waxes: Lanolin, beeswax, and others.

Examples of synthetic waxes include, but are not limited to, polyethylene wax and Fischer-Tropsch wax.

Additionally, modified waxes may be used. Examples of modified waxes include, but are not limited to, paraffin wax derivatives, montan wax derivatives, and microcrystalline wax derivatives.

These waxes may be used individually or in combination of two or more. From the perspective of film-forming properties and slipperiness, polyethylene-based wax, paraffin-based wax, and carnauba wax are particularly preferred.

The melting point of wax, for example, wax particles, is preferably between 50 degrees Celsius and 160 degrees Celsius. Additionally, the melting point of the wax is preferably lower than the heating temperature used to form the image that is subjected to static friction coefficient measurement, and the difference between the wax melting point and the heating temperature is preferably at most 40 degrees Celsius. In this case, the added wax tends to orient on the surface, improving liquid stability and discharging stability as a liquid.

If the ink contains wax, the wax content should be at least 0.5 percent by mass in terms of solid content relative to the entire ink. A wax content of at least 0.5 percent by mass allows the desired friction coefficient to be achieved.

The solid content of the wax is preferably at most 5.0 percent by mass and more preferably between 0.8 percent by mass and 2.0 percent by mass relative to the entire ink. When the wax solid content falls within this range, it becomes easier to control the friction coefficient, and discharging stability is more easily maintained. Additionally, maintaining the wax content within this range can further enhance friction fastness while ensuring the desired friction coefficient.

The particle size (diameter) of the wax is preferably at least 0.01 μm and more preferably between μm 0.01 and 0.1 μm. By ensuring a particle size of at least 0.01 μm, the wax particles are more likely to align on the surface of the pre-processing fluid, making it easier to reduce the friction coefficient of the image.

The wax can be procured.

Specific examples of commercially available products include, but are not limited to, the HiTEC series by TOHO Chemical Industry Co., Ltd., the AQUACER series by BYK, and SELOSOL 524 and TRASOL CN by CHUKYO YUSHI CO., LTD.

### Organic Solvent

There is no specific limitation to the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvents include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkylethers such as ethylene glycol monoethylether, ethylene glycol monobutyl ether, diethylene glycol monomethylether, diethylene glycol monocthylether, diethylene glycol monobutyl ether, tetraethylene glycol monomethylether, and propylene glycol monocthylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propionamide, and 3-buthoxy-N,N-dimethyl propionamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent with a boiling point of at most 250 degrees Celsius, which serves as a humectant that dries quickly.

The proportion of the organic solvent in the ink has no particular limit and can be suitably selected to suit to a particular application.

The proportion in the entire of the ink is preferably from 10 to 60 percent by mass and more preferably from 20 to 60 percent by mass to enhance drying property and discharging reliability of the ink.

### Pigment

The pigment includes an inorganic pigment and organic pigment. These can be used alone or in combination. Mixed crystal can also be used as the coloring material. The pigment is also referred to as coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black available from known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The proportion of the coloring material in ink is preferably from 0.1 to 15 percent by mass and more preferably from 1 to 10 percent by mass to enhance the image density, fixability, and discharging stability.

To obtain the ink, the pigment is dispersed by, for example, preparing a self-dispersible pigment by introducing a hydrophilic functional group into the pigment, coating the surface of the pigment with resin, or using a dispersant.

To introduce a hydrophilic group into a pigment to make a pigment self-dispersible, it is possible to add a functional group such as a sulfone group and a carboxyl group to a pigment (e.g., carbon) to make the pigment dispersible in water.

One method of coating the surface of a pigment with resin and dispersing it is to encapsulate the pigment in microcapsules, allowing it to be dispersed in water. This microencapsulated pigment is also referred to as a resin-coated pigment. The resin-coated pigment particles in ink are not necessarily entirely coated with resin.

Pigment particles not partially or wholly covered with resin may be dispersed in ink unless such particles have an adverse impact.

One such method of using a dispersant for dispersing a pigment is to use a known dispersant of a small or large molecular weight, typically a surfactant.

As the dispersant, an anionic surfactant, a cationic surfactant, a nonionic surfactant, an amphoteric surfactant, or others can be selected depending on a pigment.

Also, a nonionic surfactant, RT-100, available from TAKEMOTO OIL & FAT CO., LTD. and a formalin condensate of naphthalene sodium sulfonate are suitable as the dispersant.

Those can be used alone or in combination.

### Pigment Dispersion

It is possible to obtain an ink by mixing a coloring material with a material such as water and an organic solvent. It is also possible to mix a pigment with water, a dispersant, and other substances to prepare a pigment dispersion and thereafter mix the pigment dispersion with materials such as water and an organic solvent to manufacture ink.

The particle size of this pigment dispersion is adjusted by dispersing with water, a pigment, a pigment dispersant, and other optional components. It is good to use a dispersing device for dispersion.

The particle diameter of the pigment in the pigment dispersion has no particular limit. For example, when the maximum frequency is preferably from 20 to 500 nm and more preferably from 20 to 150 nm in the maximum number conversion, dispersion stability of the pigment is enhanced and discharging stability and the image quality such as image density are also improved. The particle diameter of a pigment can be analyzed using a particle size analyzer (Nanotrac Wave-UT151, available from MicrotracBEL Corp).

The proportion of the pigment in the pigment dispersion is not particularly limited and can be suitably selected to suit a particular application. It is preferably from 0.1 to 50 percent by mass and more preferably from 0.1 to 30 percent by mass to achieve good discharging stability and high image density.

It is preferable that the pigment dispersion be filtered with an instrument such as filter and a centrifuge to remove coarse particles followed by deaerating.

### Resin

The ink for use in the present disclosure contains a resin. The inclusion of resin in ink enhances its friction fastness.

The resin may be added to the ink in any form; however, it is preferably included in a state where resin particles are dispersed in the ink composition.

The resin particles generally bind together as water, the main solvent in aqueous inks, or a water-soluble organic solvent in the ink evaporates or penetrates, thereby promoting the fixing of the pigment onto the printing medium.

The distinction between the resin and the aforementioned wax can be made, for example, based on their melting points.

For instance, the resin can be distinguished from the wax in that it does not have a melting point within the range of 50 degrees Celsius to 160 degrees Celsius.

The type of the resin contained in the ink has no particular limit and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to obtain an ink by mixing a resin emulsion in which such resin particles are dispersed in water as a dispersion medium with materials such as a coloring material and an organic solvent. The resin particle can be synthesized or procured. These resins can be used alone or two or more types of the resin particles.

The volume average particle diameter of the resin particle is not particularly limited and can be suitably selected to suit to a particular application. The volume average particle diameter is preferably from 10 to 1,000 nm, more preferably from 10 to 200 nm, and particularly preferably from 10 to 100 nm to achieve good fixability and image robustness.

The volume average particle diameter can be measured by using a device such as a particle size analyzer (Nanotrac Wave-UT151, available from MicrotracBEL Corp.).

The resin content in the ink is at least 6 percent by mass. In this case, it becomes easier to achieve the desired range of the friction coefficient. Additionally, from the perspective of fixing properties and ink storage stability, the resin content is preferably at most 30 percent by mass and more preferably at most 20 percent by mass. Furthermore, a resin content of at least 10 percent by mass is preferable.

### Additive

The ink may further optionally include additives such as a surfactant, defoaming agent, preservative and fungicide, corrosion inhibitor, and pH regulator.

### Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application.

Of these, the surfactants not decomposable in a high pH environment are preferable. Examples include, but are not limited to, side chain modified polydimethyl siloxane, both terminal-modified polydimethyl siloxane, one-terminal-modified polydimethyl siloxane, and side-chain-both-terminal-modified polydimethyl siloxane. Silicone-based surfactants having a polyoxyethylene group or a polyoxyethylene polyoxypropylene group as a modification group are particularly preferable because such an aqueous surfactant demonstrates good properties. The silicone-based surfactant includes a polyether-modified silicone-based surfactant, one of which is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The proportion of the surfactant in ink is not particularly limited and it can be suitably selected to suit a particular application. It is preferably from 0.001 to 5 percent by mass and more preferably from 0.05 percent by mass to 5 percent by mass to achieve good wettability and discharging stability and enhance the image quality.

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Preservatives and Fungicides

The preservatives and fungicides are not particularly limited. One specific example is 1,2-benzisothiazoline-3-one.

### Corrosion Inhibitor

The corrosion inhibitor has no particular limit.

Specific examples include, but are not limited to, acid sulfites and sodium thiosulfates.

### pH Regulator

The pH regulator is not particularly limited as long as it can control the pH to 7 or greater. It includes, but is not limited to, amines such as diethanol amine and triethanol amine.

### Pre-Processing Fluid

Next, the pre-processing fluid of the present disclosure is described.

The pre-processing fluid of the present disclosure is used in a device for discharging a liquid that discharges ink onto fabric to which the pre-processing fluid has been applied.

The ink contains water, an organic solvent, a resin, and a pigment, and the static friction coefficient of an image formed by applying the pre-processing fluid to the fabric, applying the ink thereto, and heating is at most 0.47.

The resin is contained in the ink at at least 6 percent by mass. The ink either contains silicone oil or wax with a solid content in the ink at at least 0.5 percent by mass.

The pre-processing fluid contains a flocculant in an amount of at most 35 percent by mass.

The pre-processing fluid of the present disclosure forms images with excellent friction fastness (rub fastness) even when fabric is pre-treated. Additionally, the pre-processing fluid of the present disclosure can reduce ink bleeding and strike-through.

The ink set of the present disclosure contains an ink with good liquid stability and discharging stability, and a pre-processing fluid that can prevent ink bleeding and strike-through, enabling the formation of an image with excellent friction fastness even when fabric is subjected to pre-treatment.

The pre-processing fluid contains an aggregating agent (flocculant), an organic solvent, water, and optional materials such as a surfactant, a defoaming agent, a pH regulator, a preservatives and fungicides, and a corrosion inhibitor. The organic solvent, the surfactant, the defoaming agent, the pH regulator, the preservatives and fungicides, and the corrosion inhibitor are the same materials as those for use in ink and materials for use in known processing fluid. The flocculant is described next and the descriptions for the same materials as those for the ink are redundant and omitted.

### Flocculant

The type of the flocculant is not particularly limited, but it is preferably an organic acid or a polyvalent metal salt. Organic acids and polyvalent metal salts are preferred because they promote pigment aggregation more efficiently, thereby reducing image bleeding.

There are no particular restrictions on the organic acids used in the pre-processing fluid. It is preferable to include a carboxylic acid with six or fewer carbon atoms. Carboxylic acids with six or fewer carbon atoms exhibit high water solubility, preventing the separation of water and carboxylic acid during long-term storage, which enhances the stability of the pre-processing fluid.

Specific examples of carboxylic acids with six or fewer carbon atoms include, but are not limited to, saturated fatty acids such as formic acid, acetic acid, propionic acid, butyric acid, valeric acid, and hexanoic acid, as well as hydroxy acids such as lactic acid, malic acid, and citric acid. The carbon chain may be linear or branched, and it may be saturated or unsaturated. Among them, lactic acid and citric acid are preferably used. In this case, rub fastness and color development are improved.

There are no particular limitations on the polyvalent metal salts used in the pre-processing fluid.

Specific examples include, but are not limited to, magnesium sulfate, aluminum sulfate, manganese sulfate, nickel sulfate, iron (II) sulfate, copper (II) sulfate, zinc sulfate, calcium nitrate, iron (II) nitrate, iron (III) nitrate, cobalt nitrate, strontium nitrate, copper (II) nitrate, nickel (II) nitrate, lead (II) nitrate, manganese (II) nitrate, nickel (II) chloride, calcium chloride, and tin (II) chloride. From the perspective of maintaining appropriate ink aggregation, divalent metal salts are preferred.

Other flocculant may also be used, such as cationic polymers.

Specific examples of cationic polymers include, but are not limited to, allylamine hydrochloride polymer and similar polymers.

The content of the aggregating agent in the pre-processing fluid is at most 35 percent by mass. In this case, it becomes easier to achieve the desired range of the friction coefficient. Additionally, the content of the flocculant in the pre-processing fluid is preferably at least 1 percent by mass and more preferably at least 2 percent by mass relative to the entire of the pre-processing fluid. A content of at least 1 percent by mass promotes pigment aggregation, thereby reducing image bleeding.

Furthermore, the content is preferably at most 30 percent by mass, and more preferably 15 percent by mass, relative to the entire of the pre-processing fluid. If the flocculant content is within these limits, the effect of the pigment remaining on the fabric surface does not become excessive, making it easier to maintain rub fastness.

### Recorded Matter

In the present disclosure, recorded matter can be obtained, which has an image formed on fabric using the ink set of the present disclosure. The recorded matter may also be referred to as printed matter or inkjet-printed matter. A device for discharging a liquid and a method of discharging a liquid can be used to discharge the pre-processing fluid and ink to obtain the recorded matter. The recorded matter obtained through the present disclosure exhibits excellent friction fastness.

### Fabric

Examples of the fabric used in the present disclosure include woven fabrics and knitted fabrics. Fibers used to form the fabric include natural fibers such as cotton, rayon, hemp, silk, and wool, semi-synthetic fibers such as acetate and triacetate, and synthetic fibers such as polyester, polyamide, and acrylic.

### Device for Discharging Liquid and Method of Discharging Liquid

The device for discharging a liquid and the method of discharging a liquid relating to the present disclosure will be described below. The device for discharging a liquid can be used as a recording device, a printing device, an image forming apparatus, an inkjet printing apparatus, and other devices, and the method of discharging a liquid can be used as a recording method, a printing method, an image forming method, an inkjet recording method, and other methods.

The device for discharging a liquid of the present disclosure includes the ink set of the present disclosure for fabric.

One embodiment of the device for discharging a liquid of the present disclosure includes a device for applying the pre-processing fluid contained in the ink set to a fabric and a device for discharging the ink contained in the ink set onto the fabric.

The method of discharging a liquid of the present disclosure uses the ink set of the present disclosure.

One embodiment of the method of discharging a liquid of the present disclosure includes applying the pre-processing fluid contained in the ink set to fabric and discharging the ink contained in the ink set onto the fabric.

There are no particular limitations on the device for applying the pre-processing fluid to the fabric or application process of applying the pre-processing fluid to the fabric, and they can be appropriately selected according to a particular application.

Specific examples include, but are not limited to, an inkjet head, a sprayer, a hand spray, a coating roller, and a brush. Among these, discharging using an inkjet head is preferable.

One embodiment of the device for discharging a liquid of the present disclosure includes a first discharging device for discharging the pre-processing fluid onto a fabric and a second discharging device for discharging the ink onto the fabric after the pre-processing fluid is discharged.

One embodiment of the method of discharging a liquid of the present disclosure uses the ink set of the present disclosure, including a first discharging that discharges the pre-processing fluid onto a fabric and a second discharging that discharging the ink onto the fabric after the pre-processing fluid is discharged.

According to the device for discharging a liquid and the method of discharging a liquid of the present disclosure, it is possible to form an image with excellent friction fastness even on a pre-treated fabric.

The device for discharging a liquid of the present disclosure may furthermore optionally include a heating device for heating the fabric onto which the ink is discharged. If the ink contains wax and the device for discharging a liquid includes a heating device, it is preferable that the heating temperature of the heating device be higher than the melting point of the wax and that the difference between the heating temperature of the heating device and the melting point of the wax be at most 40 degrees Celsius.

The method of discharging a liquid of the present disclosure may also include heating the fabric onto which the ink is discharged. If the ink contains wax and the method of discharging a liquid includes heating, it is preferable that the heating temperature in the heating be higher than the melting point of the wax and that the difference between the heating temperature in the heating and the melting point of the wax is at most 40 degrees Celsius.

By setting the heating temperature higher than the melting point of the wax and ensuring that the difference between the heating temperature and the melting point of the wax is at most 40 degrees Celsius, the wax orients itself on the surface of the ink layer on the fabric, making it easier to achieve the desired static friction coefficient. This also improves friction fastness.

If the static friction coefficient of the image after heating is at most 0.47, intermediate processes such as heating (drying) or applying a post-processing liquid may be included between the application of the pre-processing fluid and the application of the ink, as well as between the application of the ink and heating (drying). That the static friction coefficient of the image after heating is at most 0.47, as regulated by the ink set of the present disclosure, refers to the static friction coefficient of the image after applying the pre-processing fluid to the fabric, applying the ink, and then heating.

As long as the ink set of the present disclosure is used, in the device for discharging a liquid and method of discharging a liquid of the present disclosure, intermediate processes such as heating (drying) or the application of a post-processing liquid may be included between the application of the pre-processing fluid and the application of the ink, as well as between the application of the ink and heating (drying).

Hereinafter, the device for discharging a liquid and method of discharging a liquid will be further explained using a recording device and recording method as examples. In the following description, heating and drying are described separately; however, in the present specification, heat treatment includes drying treatment.

The ink set of the present disclosure can be suitably used for various recording devices employing an inkjet recording method, such as printers, facsimile machines, photocopiers, multifunction peripherals (serving as a printer, a facsimile machine, and a photocopier), and solid freeform fabrication devices (3D printers, additive manufacturing devices, other equipment).

In the present disclosure, the printing device and the printing method respectively represent a device capable of discharging ink and liquids such as processing fluids to a printing medium and a method of printing utilizing such a device. The recording (printing) medium refers to an item to which ink or processing fluids can be temporarily or permanently attached.

The recording (printing) device may furthermore optionally include a device relating to feeding, conveying, and ejecting a printing medium and other devices referred to as a pre-processing device and a post-processing device in addition to the head portion for discharging an ink.

The printing device and the printing method may further optionally include a heater for use in the heating process and a drier for use in the drying process. For example, the heating device and the drying device include devices including heating and drying the print surface of a printing medium and the opposite surface thereof. The heating device and the drying device are not particularly limited. For example, a fan heater and an infra-red heater can be used. Heating and drying can be conducted before, in the middle of, or after printing.

In addition, the printing device and the printing method are not limited to those producing meaningful visible images such as text and figures with ink. Devices for creating patterns like geometric design and 3D images are included.

In addition, the printing device includes both a serial type device with a movable liquid discharging head and a line type device with a fixed liquid discharging head, unless otherwise specified.

Furthermore, in addition to the desktop type, this printing device includes a device capable of printing images on a wide printing medium having, for example, A0 size, and a continuous printer capable of using continuous paper rolled up in a roll-like form as a printing medium.

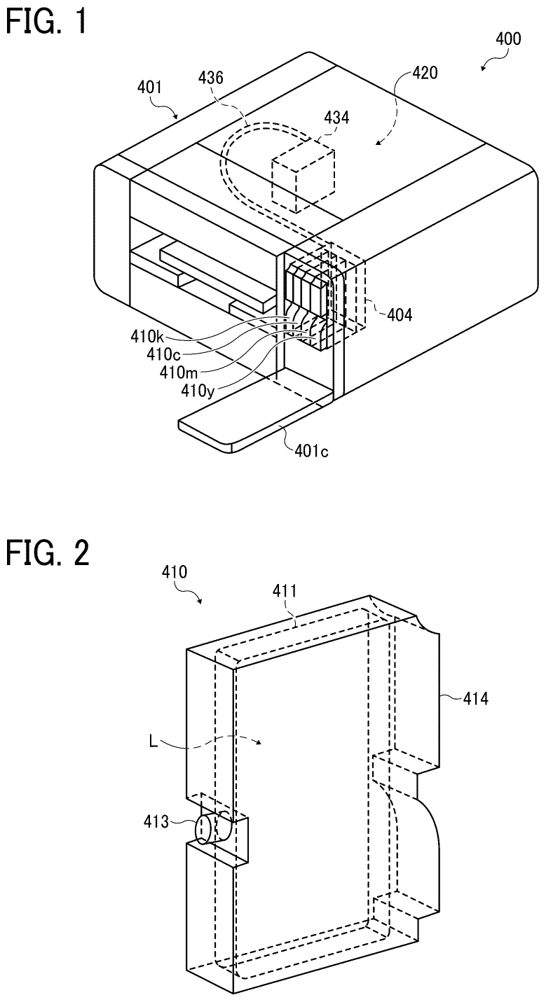

The recording (print) device is described using an example with reference to FIG. 1 and FIG. 2. FIG. 1 is a diagram illustrating a perspective view of the same device. FIG. 2 is a diagram illustrating a perspective view of a tank. An image forming apparatus 400 as an embodiment of the printing device is a serial image forming apparatus. The image forming apparatus 400 includes a mechanical unit 420 inside an exterior 401. Each ink accommodating unit (ink container) 411 of each tank 410 (410k, 410c, 410m, and 410y) for each color of black (K), cyan (C), magenta (M), and yellow (Y) is made of a packaging member such as aluminum laminate film. The ink accommodating unit 411 is housed in, for example, a plastic container housing unit 414 and L represents liquid contained in the ink accommodating unit 411. The tank 410 is used as an ink cartridge of each color. Each color ink is not limited to black (K), cyan (C), magenta (M), and yellow (Y) but to other color ink such as white (W) and metallic ink. Each color tank 410 and each ink accommodating unit 411 are not limited in the same manner as those.

A cartridge holder 404 is disposed on the rear side of the opening appearing when a cover 401c is opened. The tank 410 is detachably attached to the cartridge holder 404. This configuration enables each ink discharging outlet 413 of the tank 410 to communicate with a discharging head 434 for each color via a supplying tube 436 for each color so that the ink can be discharged from the discharging head 434 to a printing medium.

The pre-processing fluid may be discharged from the discharging head 434 or from another discharging head. Additionally, the pre-processing fluid is appropriately filled into a tank or an ink storage container.

The terms of image forming, recording, and printing in the present disclosure represent the same meaning. Also, recording (printing) media, media, and printed matter in the present disclosure have the same meaning unless otherwise specified.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, embodiments of the present disclosure are described in detail with reference to Examples but are not limited thereto.

### Preparation of Pre-Processing Fluid and Ink

### Preparation of Black Pigment Dispersion A

### Preparation of Polymer Solution A

After a through replacement with nitrogen gas in a one litter flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethylene glycol methacrylate, 4.0 g of styrene macromer, and 0.4 g of mercapto ethanol were admixed in the flask followed by heating to 65 degrees Celsius.

Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer, 3.6 g of mercapto ethanol, 2.4 g of azobismethyl valeronitrile, and 18 g of methylethyl ketone was added dropwise to the flask in two and a half hours.

Subsequently, a liquid mixture of 0.8 g of azobismethyl valeronitrile and 18 g of methylethyl ketone was added dropwise to the flask in half an hour. The resulting mixture was aged at 65 degrees Celsius for one hour. Thereafter, 0.8 g of azobismethyl valeronitrile was added followed by aging for another hour. After the reaction was complete, 364 g of methylethyl ketone was added to the flask to obtain 800 g of polymer solution A having a concentration of 50 percent by mass.

Preparation of Liquid Dispersion of Polymer Fine Particle Containing Pigment Twenty eight g of the polymer solution A, 42 g of carbon black pigment (Monarch 800, available from Cabot Corporation), 13.6 g of 1 mol/L potassium hydroxide aqueous solution, 20 g of methylethyl ketone, and 13.6 g of deionized water were sufficiently stirred and then mixed and kneaded using a roll mill.

The thus-obtained paste was charged in 200 g of pure water followed by sufficient stirring. Thereafter, methylethyl ketone and water were distilled away using an evaporator. To remove coarse particles, the thus-obtained liquid dispersion was filtered with a polyvinylidene fluoride membrane filter having an average hole diameter of 5.0 μm under pressure. As a result, a liquid dispersion of resin-coated black pigment A was obtained which included a pigment portion in an amount of 15 percent by mass with a solid portion concentration of 20 percent by mass.

### Preparation of Black Pigment Dispersion B

A total of 100 g of carbon black (SEAST SP, SRF-LS, available from TOKAI CARBON CO., LTD.) was added to 3,000 mL of sodium hypochlorite at 2.5 normal, followed by stirring at 300 rpm at 60 degrees Celsius to allow reaction for 10 hours for oxidization. As a result, a pigment in which a carboxylic acid group was placed on the surface of carbon black was obtained.

The reaction liquid was filtered and the thus-filtered carbon black was neutralized with sodium hydroxide solution followed by ultra-filtering.

Thereafter, the resulting pigment dispersion and deionized water were subjected to ultra filtration by dialysis membrane followed by ultrasonic dispersion so that self dispersive black pigment dispersion B having a pigment solid content concentrated to 20 percent was obtained.

### Preparation of Pre-Processing Fluid and Ink

Inks 1 to 9 and Pre-processing Fluids 1 to 8 were obtained by mixing and stirring the materials according to the prescriptions and proportions (percent by mass) shown in Tables 1 and 2, followed by filtration using a 0.8 μm cellulose acetate filter (Minisart, available from Sartorius AG).

For the resin emulsions and pigments, the added amounts are indicated as solid content.

The details of the materials shown in Tables 1 and 2 are as follows.
Surfinol 440 (acetylene glycol surfactant, available from Nissin Chemical co., ltd.)
SAG-014 (SILFACE, silicone surfactant, available from Nissin Chemical co., ltd.)
AQUACER 2500 (Polyethylene wax available from Byk-Chemie: Melting point 125 degrees Celsius)
AQUACER 513 (Polyethylene wax available from Byk-Chemie: Melting point 135 degrees Celsius)
AQUACER 593 (Polypropylene wax available from Byk-Chemie: Melting point 160 degrees Celsius)
CA-179 (Polyethylene wax available from CHUKYO YUSHI CO., LTD.: Melting point 110 degrees Celsius)
TEGO GLIDE 450 (Silicone oil, available from Evonik Industries AG)
LUBRIJET T340 (Acrylic resin emulsion, available from The Lubrizol Corporation)
PERMARIN UA-368 (Urethane resin emulsion available from SANYO CHEMICAL INDUSTRIES)
Elitel® KT-0507 (Polyester resin emulsion available from UNITIKA LTD.)
HYDRAN™ CP-7610 (Cationic urethane resin emulsion, available from DIC Corporation)
PAA-HCL-01 (Allylamine hydrochloride polymer, available from NITTOBO MEDICAL CO., LTD.)
Proxel LV (Preservative, available from arxada JAPAN)

TABLE 1

| | | Preparation Example of ink | | | | |
|---|---|---|---|---|---|---|
| | | 1 | 2 | 3 | 4 | 5 |
| Ink | 1,2-propane diol | 20 | 15 | | 10 | 5 |
| Prescription | Glycerin | 10 | | 25 | 10 | 20 |
| | 1,3-butane diol | | 15 | | 10 | |
| | Surfynol 440 | 0.5 | | 1.2 | | 0.2 |
| | SAG-014 | | 0.5 | | 0.3 | 0.2 |
| | AQUACER 2500 (solid content) | 2 | | | | |
| | AQUACER 513 (solid content) | | 1 | | | |
| | AQUACER 593 (solid content) | | | | 1.5 | |
| | CA-179 (solid content) | | | | | 1.5 |
| | Glide450 | | | 2.5 | | |
| | Lubrijet T340 (solid content) | 12 | | | 5 | 6 |
| | UA-368 (solid content) | | 11 | | 6 | |
| | KT-0507 (solid content) | | | 10 | | 4 |
| | Black pigment dispersion A | 5 | 4 | | | |
| | (solid mass) | | | | | |
| | Black pigment dispersion B | | | 4.5 | | |
| | (solid mass) | | | | | |
| | PROXEL LV | 0.1 | 0.1 | 0.1 | 0.1 | 0.1 |
| | Highly pure water | Balance | Balance | Balance | Balance | Balance |
| | Total amount | 100 | 100 | 100 | 100 | 100 |

| | | Preparation Example of ink | | | |
|---|---|---|---|---|---|
| | | 6 | 7 | 8 | 9 |
| Ink | 1,2-propane diol | 20 | 20 | 20 | 20 |
| Prescription | Glycerin | 10 | 10 | 10 | 10 |
| | 1,3-butane diol | | | | |
| | Surfynol 440 | 0.5 | 0.5 | 0.5 | 0.5 |
| | SAG-014 | | | | |
| | AQUACER 2500 (solid content) | 0.7 | 2.2 | 0.3 | 2 |
| | AQUACER 513 (solid content) | | | | |
| | AQUACER 593 (solid content) | | | | |
| | CA-179 (solid content) | | | | |
| | Glide450 | | | | |
| | Lubrijet T340 (solid content) | 12 | 12 | 12 | 5 |
| | UA-368 (solid content) | | | | |
| | KT-0507 (solid content) | | | | |
| | Black pigment dispersion A | 5 | 5 | 5 | 7 |
| | (solid mass) | | | | |
| | Black pigment dispersion B | | | | |
| | (solid mass) | | | | |
| | PROXEL LV | 0.1 | 0.1 | 0.1 | 0.1 |
| | Highly pure water | Balance | Balance | Balance | Balance |
| | Total amount | 100 | 100 | 100 | 100 |

TABLE 2

| | | Preparation Example of pre- | | | |
|---|---|---|---|---|---|
| | | processing fluid | | | |
| | | 1 | 2 | 3 | 4 |
| Prescription | 1,2-propane diol | 20.0 | 10.0 | | 20.0 |
| of pre- | Glycerin | | 10.0 | 15.0 | |
| processing | Diethylene glycol monobutyl ether | 5.0 | 10.0 | | |
| fluid | CP-7610 (solid content) | 3.0 | | | |
| | Calcium nitrate | 15.0 | | | |
| | Magnesium acetate | | 20.0 | | |
| | Calcium chloride | | | | 15.0 |
| | Potassium nitrate | | | | |
| | Lactic acid | | | 15.0 | |
| | Citric acid | | | | |
| | PAA-HCL-01 (effective component) | | | | |
| | PROXEL LV | 0.1 | 0.1 | 0.1 | 0.1 |
| | Highly pure water | Balance | Balance | Balance | Balance |
| | Total amount | 100 | 100 | 100 | 100 |
| | | Preparation Example of pre- | | | |
| | | processing fluid | | | |
| | | 5 | 6 | 7 | 8 |
| Prescription | 1,2-propane diol | 10.0 | 20.0 | 20.0 | 20.0 |
| of pre- | Glycerin | 10.0 | | | |
| processing | Diethylene glycol monobutyl ether | 5.0 | | | |
| fluid | CP-7610 (solid content) | | | | |
| | Calcium nitrate | | | | 20.0 |
| | Magnesium acetate | | | | |
| | Calcium chloride | | | | |
| | Potassium nitrate | | | 25.0 | |
| | Lactic acid | | | | 20.0 |
| | Citric acid | 12.0 | | | |
| | PAA-HCL-01 (effective component) | | 10.0 | | |
| | PROXEL LV | 0.1 | 0.1 | 0.1 | 0.1 |
| | Highly pure water | Balance | Balance | Balance | Balance |
| | Total amount | 100 | 100 | 100 | 100 |

### Examples 1 to 11 and Comparative Examples 1 to 3

Regarding Examples 1 to 11 and Comparative Examples 1 to 3, printing was performed on the printing substrates listed in Tables 3 and 4 using the combination of the inks and the pre-processing fluids shown in Tables 3 and 4 to evaluate the properties in the following manner.

The printing substrates (fabrics) shown in Tables 3 and 4 are as follows.
Cotton Broadcloth: Cotton broadcloth with 40 s yarn count, available from SHIKISENSHA CO., LTD.—Polyester Tropical: Polyester tropical fabric (Teijin) available from SHIKISENSHA CO., LTD. 10
Blended Broadcloth: T/C broadcloth, available from SHIKISENSHA CO., LTD.

### Method of Producing Printed Matter

The inks and pre-processing fluids used in Examples and Comparative Examples were filled into separate devices (RICOH Ri 100, available from Ricoh Co., Ltd.). The attached amounts of both the pre-processing fluid and the ink were adjusted to 20 g/m². Next, the pre-processing fluid was discharged onto the printing substrates shown in the table, followed by ink discharging, and a solid printing was performed at 600 dpi×600 dpi. The printed matter was then dried in an oven at the drying temperatures specified in the table for 10 minutes.

### Measurement of Static Friction Coefficient

The solid images prepared by executing the method above mentioned were cut into strips of approximately 15 cm in length and placed in an automatic friction and wear analyzer (TSf-503, available from Kyowa Interface Science Co., Ltd.). The cut image was rubbed under the following measuring conditions, and the static friction coefficient was determined based on the friction coefficient at the moment the movement started.

### Measuring Conditions

Load: 200 g
Measuring speed: 1000 mm/min
Measuring distance: 30 mm
Contact maker: R contact

### Evaluation of Dry Friction Fastness

The solid images prepared by executing the method above mentioned were subjected to a friction fastness test (dry rubbing) according to a JIS L0849 (test methods for color fastness to rubbing)-compliant Gakushin-type friction fastness tester. The optical density (OD) of the transferred ink on cotton fabric was measured, and the results were evaluated based on the following criteria. Grades A and B are considered acceptable.

### Evaluation Criteria

A: Transfer OD of the cotton fabric after testing is less than 0.10
B: Transfer OD of the cotton fabric after testing is 0.10 to less than 0.15
C: Transfer OD of the cotton fabric after testing is at least 0.15

### Evaluation on Color Development

The image density of the solid prints prepared by executing the method mentioned above was measured using an X-Rite Exact spectrophotometer, available from X-Rite, Inc. and the results were evaluated based on the following criteria. Grades A and B are considered acceptable.

### Evaluation Criteria

A: Density of the solid portion is at least 0.14
B: Density of the solid area is 0.13 to less than 0.14
C: Density of the solid area is less than 0.13

### Evaluation on Discharging Stability

The prepared inks were filled into a Ricoh IPSiO GXe5500 printer. A test chart was printed on plain paper (My Paper, available from Ricoh Co., Ltd.) with dots arranged every other nozzle. The positions where the ink droplets reached were observed using a microscope, and the results were evaluated based on the following criteria. Grades A and B are considered practically acceptable.

### Evaluation Criteria

A: No missing or misaligned dots observed
B: Slight misalignment of dots due to discharge deviation is observed
C: Missing dots due to non-discharge or significant misalignment is observed

TABLE 3

| | Example 1 | Example 2 | Example 3 | Example 4 |
|---|---|---|---|---|
| Preparation Example of | 1 | 2 | 3 | 4 |
| pre-processing fluid | | | | |
| Preparation Example of Ink | 1 | 2 | 3 | 4 |
| Printing substrate | Cotton | Cotton | Cotton | Polyester |
| | Broadcloth | Broadcloth | Broadcloth | TropicalCotton |
| | | | | broad |
| Static friction coefficient | 0.42 | 0.45 | 0.47 | 0.45 |
| Drying temperature (degrees Celsius) | 145 | 120 | 145 | 120 |
| Added amount (percent by mass) of wax | 2.0 | 1.0 | — | 1.5 |
| Wax melting point (degrees Celsius) | 125 | 135 | — | 160 |
| Difference (degrees Celsius) between | 20 | 15 | — | 40 |
| melting point and drying temperature | | | | |
| Flocculant | Calcium | Magnesium | Lactic acid | Calcium |
| | nitrate | acetate | | chloride |
| Dry rubbing fastness | A | A | A | A |
| Coloring | A | A | A | A |
| Discharging stability | A | A | A | A |
| | Example 5 | Example 6 | Example 7 | Example 8 |
| Preparation Example of | 5 | 1 | 1 | 1 |
| pre-processing fluid | | | | |
| Preparation Example of Ink | 5 | 1 | 1 | 6 |
| Printing substrate | Blended | Cotton | Cotton | Cotton |
| | Broadcloth | Broadcloth | Broadcloth | Broadcloth |
| Static friction coefficient | 0.43 | 0.47 | 0.47 | 0.47 |
| Drying temperature (degrees Celsius) | 80 | 125 | 80 | 145 |
| Added amount (percent by mass) of wax | 1.5 | 2.0 | 2.0 | 0.7 |
| Wax melting point (degrees Celsius) | 110 | 125 | 125 | 125 |
| Difference (degrees Celsius) between | 30 | 0 | 45 | 20 |
| melting point and drying temperature | | | | |
| Flocculant | Citric acid | Calcium | Calcium | Calcium |
| | | nitrate | nitrate | nitrate |
| Dry rubbing fastness | A | B | B | B |
| Coloring | A | A | A | A |
| Discharging stability | A | A | A | A |

| | Example 9 | Example 10 | Example 11 |
|---|---|---|---|
| Preparation Example of | 1 | 6 | 7 |
| pre-processing fluid | | | |
| Preparation Example of Ink | 7 | 1 | 1 |
| Printing substrate | Cotton | Cotton | Cotton |
| | Broadcloth | Broadcloth | Broadcloth |
| Static friction coefficient | 0.42 | 0.41 | 0.41 |
| Drying temperature (degrees Celsius) | 145 | 145 | 145 |
| Added amount (percent by mass) of wax | 2.2 | 2.0 | 2.0 |
| Wax melting point (degrees Celsius) | 125 | 125 | 125 |
| Difference (degrees Celsius) between | 20 | 20 | 20 |
| melting point and drying temperature | | | |
| Flocculant | Calcium | Cationic | Potassium |
| | nitrate | polymer A | nitrate |
| Dry rubbing fastness | A | B | B |
| Coloring | A | B | B |
| Discharging stability | B | A | A |

TABLE 4

| | Comparative | Comparative | Comparative |
|---|---|---|---|
| | Example 1 | Example 2 | Example 3 |
| Preparation | 1 | 8 | 1 |
| Example of pre- | | | |
| processing fluid | | | |
| Preparation | 8 | 1 | 9 |
| Example of Ink | | | |
| Printing substrate | Cotton | Cotton | Cotton |
| | Broadcloth | Broadcloth | Broadcloth |
| Static friction | 0.48 | 0.50 | 0.54 |
| coefficient | | | |
| Drying temperature | 145 | 145 | 145 |
| (degrees Celsius) | | | |
| Added amount | 0.3 | 2.0 | 2.0 |
| (percent by mass) | | | |
| of wax | | | |
| Wax melting point | 125 | 125 | 125 |
| (degrees Celsius) | | | |
| Difference (degrees | 20 | 20 | 20 |
| Celsius) between | | | |
| melting point and | | | |
| drying temperature | | | |
| Flocculant | Calcium | Calcium | Calcium |
| | nitrate | nitrate | nitrate |
| Dry rubbing fastness | C | C | C |
| Coloring | A | A | B |
| Discharging | A | A | A |
| stability | | | |

As seen in the results shown above, according to the present disclosure, images with excellent friction resistance (rub fastness) can be formed even when fabric is pre-treated.

The aspects of the present disclosure are, for example, as follows:

### Aspect 1

An ink set contains a pre-processing fluid containing a flocculant in an amount of at most 35 percent by mass and an ink that contains water, an organic solvent, a resin accounting for at least 6 percent by mass of the ink, a pigment, and a silicone oil or the solid content of a wax in an amount of at least 0.5 percent by mass to the entire of the ink, wherein an image has a static friction coefficient of at most 0.47, the image being formed by applying the pre-processing fluid to a fabric, applying the ink where the pre-processing fluid is applied to the fabric, and heating the fabric.

### Aspect 2

The ink set according to Aspect 1 mentioned above, wherein the ink contains the wax, the wax having a melting point that is at most 40 degrees lower than a temperature at which the fabric is heated.

### Aspect 3

The ink set according to Aspect 1 or 2 mentioned above, wherein the ink contains the wax with a solid content ranging from 0.8 to 2.0 percent by mass to the entire of the ink.

### Aspect 4

The ink set according to any one of Aspects 1 to 3 mentioned above, wherein the flocculant contains a polyvalent metal salt or an organic acid.

### Aspect 5

A device for discharging a liquid contains a first discharging device to discharge a pre-processing fluid to a fabric and a second discharging device to discharge an ink to the fabric where the pre-processing fluid is discharged, wherein the pre-processing fluid contains a flocculant in an amount of at most 35 percent by mass and the ink contains water, an organic solvent, a resin accounting for at least 6 percent by mass of the ink, a pigment, and a silicone oil or the solid content of a wax in an amount of at least 0.5 percent by mass to the entire of the ink, wherein an image has a static friction coefficient of at most 0.47, the image being formed by applying the pre-processing fluid to the fabric, applying the ink where the pre-processing fluid is applied to the fabric, and heating the fabric.

### Aspect 6

The device according to Aspect 5 mentioned above, further includes a heating device to heat the fabric, wherein the wax has a melting point that is at most 40 degrees lower than a temperature at which the fabric is heated by the heating device.

### Aspect 7

A method of discharging a liquid includes discharging a pre-processing fluid to a fabric and discharging an ink to the fabric where the pre-processing fluid is discharged, wherein the pre-processing fluid contains a flocculant in an amount of at most 35 percent by mass and the ink contains water, an organic solvent, a resin accounting for at least 6 percent by mass of the ink, a pigment, and a silicone oil or the solid content of a wax in an amount of at least 0.5 percent by mass to an entire of the ink, wherein an image has a static friction coefficient of at most 0.47, the image being formed by applying the pre-processing fluid to the fabric, applying the ink where the pre-processing fluid is applied to the fabric, and heating the fabric.

### Aspect 8

The method according to Aspect 7 mentioned above, further includes heating the fabric where the ink is discharged, wherein the wax has a melting point that is at most 40 degrees lower than a temperature at which the fabric is heated.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An ink set comprising:
a pre-processing fluid comprising a flocculant in an amount of at most 35 percent by mass; and
an ink comprising:
water;
an organic solvent;
a resin accounting for at least 6 percent by mass of the ink;
a pigment; and
a silicone oil or a solid content of a wax in an amount of at least 0.5 percent by mass to an entire of the ink,
wherein an image has a static friction coefficient of at most 0.47, the image being formed by applying the pre-processing fluid to a fabric, applying the ink where the pre-processing fluid is applied to the fabric, and heating the fabric.

2. The ink set according to claim 1,
wherein the ink comprises the wax, the wax having a melting point that is at most 40 degrees lower than a temperature at which the fabric is heated.

3. The ink set according to claim 1,
wherein the ink comprises the wax with a solid content ranging from 0.8 to 2.0 percent by mass to the entire of the ink.

4. The ink set according to claim 1,
wherein the flocculant comprises a polyvalent metal salt or an organic acid.

5. A device for discharging a liquid comprising:
a first discharging device to discharge a pre-processing fluid to a fabric; and
a second discharging device to discharge an ink to the fabric where the pre-processing fluid is discharged,
wherein the pre-processing fluid comprises a flocculant in an amount of at most 35 percent by mass and
the ink comprises:
water;
an organic solvent;
a resin accounting for at least 6 percent by mass of the ink;
a pigment; and
a silicone oil or a solid content of a wax in an amount of at least 0.5 percent by mass to an entire of the ink,
wherein an image has a static friction coefficient of at most 0.47, the image being formed by applying the pre-processing fluid to the fabric, applying the ink where the pre-processing fluid is applied to the fabric, and heating the fabric.

6. The device according to claim 5,
further comprising a heating device to heat the fabric,
wherein the wax has a melting point that is at most 40 degrees lower than a temperature at which the fabric is heated by the heating device.

7. A method of discharging a liquid, the method comprising:
discharging a pre-processing fluid to a fabric; and
discharging an ink to the fabric where the pre-processing fluid is discharged,
wherein the pre-processing fluid comprises a flocculant in an amount of at most 35 percent by mass and
the ink comprises:
water;
an organic solvent;
a resin accounting for at least 6 percent by mass of the ink;
a pigment; and
a silicone oil or a solid content of a wax in an amount of at least 0.5 percent by mass to an entire of the ink,
wherein an image has a static friction coefficient of at most 0.47, the image being formed by applying the pre-processing fluid to the fabric, applying the ink where the pre-processing fluid is applied to the fabric, and heating the fabric.

8. The method according to claim 7,
further comprising heating the fabric where the ink is discharged,
wherein the wax has a melting point that is at most 40 degrees lower than a temperature at which the fabric is heated.
